(19) United States
(12) Patent Application Publication
(10) Pub. No.: US 2025/0056270 A1
(43) Pub. Date: Feb. 13, 2025

(54) MEASURING A QOS PARAMETER FOR A MULTIACCESS CONNECTION USING A QOS MONITORING PROCEDURE

(71) Applicants: Lenovo (Singapore) Pte. Ltd., New Tech Park (SG); LENOVO INTERNATIONAL COÖPERATIEF U.A., Amsterdam (NL)

(72) Inventors: Apostolis Salkintzis, Athens (GR); Genadi Velev, Darmstadt (DE); Dimitrios Karampatsis, Ruislip (GB)

(21) Appl. No.: 18/717,947

(22) PCT Filed: Jan. 14, 2022
(86) PCT No.: PCT/EP2022/050813

§ 371 Date: Jun. 7, 2024

(30) Foreign Application Priority Data
Dec. 7, 2021 (GR) 20210100858

(51) Int. Cl. H04W 24/08; H04W 24/10

(52) U.S. Cl. CPC H04W 24/08; H04W 24/10

(57) ABSTRACT

Apparatuses, methods, and systems are disclosed for measuring QoS parameters in a multiaccess data connection. One apparatus includes a transceiver that receives a request from a SMF to establish a multiaccess connection for a UE, where the multiaccess connection includes a set of access networks and a set of QoS flows. Here, the request includes multiple reporting events and QoS monitoring information indicating that at least one QoS monitoring procedure is to be used for taking measurements for at least one QoS parameter on each access network in the set of access networks. The processor initiates at least one QoS monitoring procedure for taking measurements for the at least one QoS parameter on each access network in the set of access networks.

### FIELD

The subject matter disclosed herein relates generally to wireless communications and more particularly relates to measuring access network performance of a multiple access (“multiaccess”) data connection using QoS monitoring procedures.

### BACKGROUND

In certain wireless networks, a User Equipment (“UE”) capable of supporting Access Traffic Steering, Switching, and/or Splitting (“ATSSS”), may simultaneously communicate over a 3GPP access network (e.g., NG-RAN) and over a non-3GPP access network (e.g., WLAN). For example, an ATSSS rule may instruct that traffic exchanged between the UE and a Remote Host is to be sent on the “best” access only, e.g., on the access characterized by the least latency, or the least Round Trip Time (“RTT”).

### BRIEF SUMMARY

Disclosed are procedures for measuring access network performance of a multiaccess data connection using QoS monitoring procedures. Said procedures may be implemented by apparatus, systems, methods, or computer program products.

One method of a User Plane Function (“UPF”) in a mobile communication network for measuring Quality of Service (“QoS”) parameters in a multiaccess data connection includes receiving, from a Session Management Function (“SMF”), a request to establish a multiaccess connection for a User Equipment (“UE”), the multiaccess connection including a set of access networks and a set of QoS flows, where the request contains a plurality of reporting events and contains QoS monitoring information indicating that at least one QoS monitoring procedure is to be used to take measurements for at least one QoS parameter on each access network in the set of access networks. The method includes initiating at least one QoS monitoring procedure for taking measurements for the at least one QoS parameter on each access network in the set of access networks.

One method of a User Equipment (“UE”) device for measuring QoS parameters in a multiaccess data connection includes sending a first message to establish a multiaccess data connection with the mobile communication network, and receiving a second message that accepts the establishment of the multiaccess data connection, where the multiaccess data connection includes a set of access networks and the second message includes a set of traffic routing rules. The method includes receiving a third message containing measurement information for the set of access networks of the multiaccess data connection. The method includes applying the measurement information and the set of traffic routing rules to determine how to transmit data traffic across the plurality of access networks of the multiaccess data connection.

One method of a session management function (“SMF”) in a mobile communication network for measuring QoS parameters in a multiaccess data connection includes receiving, from a UE, a first message to establish a multiaccess data connection and sending, to a UPF, a request to establish a multiaccess connection for the UE, where the multiaccess data connection includes a set of access networks. Here, the request includes a plurality of reporting events and includes QoS monitoring information indicating that at least one QoS monitoring procedure is to be used to take measurements are to be taken for at least one QoS parameter on each access network in the set of access networks.

The method of the SMF includes sending, to the UE, a second message that accepts the establishment of the multiaccess data connection, the second message including a set of traffic routing rules. The method includes receiving, from the UPF, an event report containing information about a first reporting event, where the information is based on measurements for the at least one QoS parameter on each access network in the set of access networks, and sending, to the UE, a third message containing measurement information derived from the received event report.

One method of a policy control function (“PCF”) in a mobile communication network for measuring QoS parameters in a multiaccess data connection includes receiving a policy request for a requested multiaccess data connection that includes a set of access networks. The method includes generating a set of rules indicating how data traffic of the multiaccess data connection is to be routed across the set of access networks and determining a plurality of reporting events and at least one QoS parameter to be measured on each access network in the set of access networks. The method includes sending a policy response that includes the set of rules, the plurality of reporting events, and the at least one QoS parameter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for measuring Quality of Service (“QoS”) parameters in a multiaccess data connection;

FIG. 2A is a call-flow diagram illustrating one embodiment of a procedure for measuring access network performance of a multiaccess data connection using QoS monitoring procedures;

FIG. 2B is a continuation of the call-flow diagram of FIG. 2A;

FIG. 2C is a continuation of the call-flow diagrams of FIGS. 2A and 2B;

FIG. 3A is a call-flow diagram illustrating one embodiment of a procedure for measuring access network performance of a multiaccess data connection using both QoS monitoring procedures and Performance Measurement Functionality (“PMF”) procedures;

FIG. 3B is a continuation of the call-flow diagram of FIG. 3A;

FIG. 3C is a continuation of the call-flow diagrams of FIGS. 3A and 3B;

FIG. 4 is a block diagram illustrating one embodiment of a user equipment apparatus that may be used for measuring QoS parameters in a multiaccess data connection;

FIG. 5 is a block diagram illustrating one embodiment of a network apparatus that may be used for measuring QoS parameters in a multiaccess data connection;

FIG. 6 is a flowchart diagram illustrating one embodiment of a first method for measuring QoS parameters in a multiaccess data connection;

FIG. 7 is a flowchart diagram illustrating one embodiment of a second method for measuring QoS parameters in a multiaccess data connection;

FIG. 8 is a flowchart diagram illustrating one embodiment of a third method for measuring QoS parameters in a multiaccess data connection; and

FIG. 9 is a flowchart diagram illustrating one embodiment of a fourth method for measuring QoS parameters in a multiaccess data connection.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for measuring access network performance of a multiaccess data connection using a QoS monitoring procedure. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

As already specified in Third-Generation Partnership Project (“3GPP”) specifications, a UE capable of supporting Access Traffic Steering, Switching, and/or Splitting (“ATSSS”), can simultaneously communicate with a 5G Core network (“5GC”) over a 3GPP access network (e.g., NG-RAN) and over a non-3GPP access network (e.g., WLAN). In such embodiments, the traffic exchanged between the UE and a Remote Host can either be distributed over both accesses (e.g., for bandwidth aggregation) or can be sent on the “best” access only, e.g., on the access characterized by the smallest latency, or the smallest Round-Trip Time (“RTT”).

In the uplink (“UL”) direction, the UE decides how to distribute the traffic across the two accesses based on policy rules (called ATSSS rules) provided by the network. Similarly, in the downlink (“DL”) direction, the UPF at the edge of 5GC decides how to distribute the traffic across the two accesses based on corresponding policy rules (called N4 rules).

In many scenarios, where communication latency is important, the policy rules may indicate that specific traffic should be routed according to a latency-dependent condition. For example, the policy rules in the UE may indicate:
“Traffic of App-X should be routed over 3GPP access, if Latency over 3GPP access<20 ms”; or
“IMS voice traffic should be routed to the access with the smallest Latency” (note that “IMS” refers to the IP Multimedia Protocol)

To enforce the above policy rules, the UE is required to measure the latency (or RTT) over 3GPP access and the latency (or RTT) over non-3GPP access. Similarly, the UPF is required to measure the latency (or RTT) over 3GPP access and the latency (or RTT) over non-3GPP access, in order to decide how to route the DL traffic in compliance with the policy rules.

In general, there are many technologies known for measuring the packet delay in Internet Protocol (“IP”) communication networks. However, even the simplest solution based on Echo Request/Echo Response messages is not very efficient, given that UEs may consume many radio and battery resources when they apply this solution for an extended period of time.

Several other technologies are known in prior art for packet delay measurements in communication networks, which rely on measurements taken by on-path proxies. In other example, the UPF in 5GC could implement a SOCKS5 proxy that terminates all User Datagram Protocol (“UDP”) and Transmission Control Protocol (“TCP”) flows of the UE and then creates corresponding outbound flows over the N6 interface (note that “SOCKS5” refers to an internet protocol that funnels web traffic through a remote server). However, the proxy operation introduces a lot of overhead and can have a severe impact on the packet throughput and on the battery consumption of UEs. Hence, such methods are not favorable for 5G mobile networks.

The 3GPP specifications specify that a Performance Measurement Functionality (“PMF”) is to be supported in the UE and in the UPF, which assists in taking real-time RTT measurements over the two accesses. In particular, the 3GPP specifications specify that RTT measurements can be taken by exchanging PMF-Echo Request/PMF-Echo Response messages between the PMF function in the UE (UE-PMF) and the PMF function in the UPF (UPF-PMF).

This way the UE (or UPF) can calculate a RTT over each access, which is tightly associated with the latency of each access. However, sending frequent PMF-Echo Request/Response messages (e.g., once every 5-10 sec) between the UE and UPF, and over UDP/IP, is very inefficient since it introduces a lot of overhead and it consumes a lot of radio, network and battery resources. Furthermore, it creates additional traffic, which can increase congestion and can result to much higher latency values.

The present disclosure describes solutions to enhance the ATSSS feature by specifying an alternative method for measuring the RTT without the need to use the PMF protocol and without the need to transmit additional information on the radio interface. Therefore, this method does not require the exchange of measurement messages between the UE and the UPF and, thus, it can improve the efficiency of the RTT measurements. As described below, the proposed method relies on the existing procedures for QoS monitoring, which support RTT measurement between the UE and the UPF.

According to a first solution, access network performance measurements of a multiaccess data connection are taken using QoS monitoring procedures on both access networks. According to a second solution, access network performance measurements of a multiaccess data connection are taken on the 3GPP access network using QoS monitoring procedures and taken on the non-3GPP access network suing PMF protocol procedures.

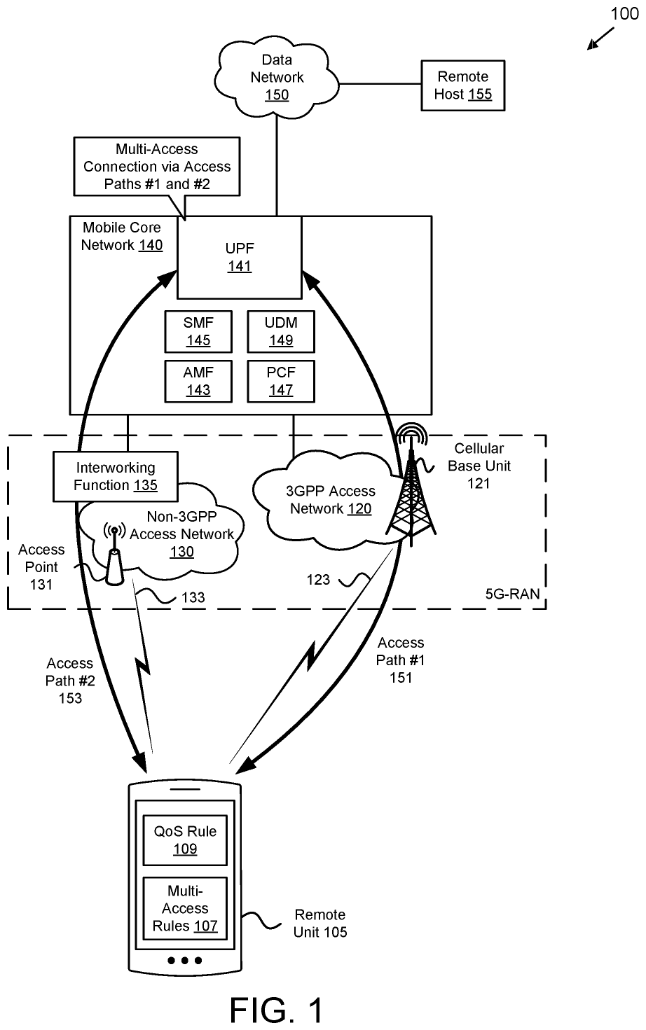

FIG. 1 depicts a wireless communication system 100 for measuring access network performance of a multiaccess data connection using QoS monitoring procedures, according to embodiments of the disclosure. In one embodiment, the wireless communication system 100 includes at least one remote unit 105, a 5G Radio Access Network (“5G-RAN”) comprising a 3GPP access network 120 and a non-3GPP access network 130, and a mobile core network 140. The 5G-RAN and the mobile core network 140 form a mobile communication network. The 3GPP access network 120 may be composed of a cellular base unit 121 with which the remote unit 105 communicates using wireless communication links 123 and the non-3GPP access network 130 may be composed of an access point 131 with which the remote unit 105 communicates using wireless communication links 133. Even though a specific number of remote units 105, cellular base units 121, wireless communication links 123, access points 131, wireless communication links 133, and mobile core networks 140 are depicted in FIG. 1, one of skill in the art will recognize that any number of remote units 105, cellular base units 121, wireless communication links 123, access points 131, wireless communication links 133, and mobile core networks 140 may be included in the wireless communication system 100.

In one implementation, the 5G-RAN is compliant with the Fifth-Generation (“5G”) cellular system specified in the Third Generation Partnership Project (“3GPP”) specifications. For example, the 3GPP access network 120 may be a Next Generation Radio Access Network (“NG-RAN”), implementing New Radio (“NR”) Radio Access Technology (“RAT”) and/or Long-Term Evolution (“LTE”) RAT. In another implementation, the 5G-RAN is compliant with the LTE system specified in the 3GPP specifications. Moreover, the non-3GPP access network 130 implements a non-3GPP RAT, such as Wi-Fi® or Institute of Electrical and Electronics Engineers (“IEEE”) 802.11-family compliant WLAN. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

In various embodiments, the remote unit 105 includes a subscriber identity and/or identification module (“SIM”) and a mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the cellular base units 121 in the 3GPP access network 120 via uplink (“UL”) and downlink (“DL”) communication signals, where the UL and DL communication signals are carried over the wireless communication links 123. Here, the 3GPP access network 120 is an intermediate network that provides the remote units 105 with access to the mobile core network 140. Similarly, the remote units 105 may communicate directly with one or more of the access points 131 in the non-3GPP access network 130 via UL and DL communication signals carried over the wireless communication links 133, where the non-3GPP access network 130 is an intermediate network that provides the remote units 105 with access to the mobile core network 140.

In some embodiments, the remote units 105 communicate with a remote host 155 via a network connection with the mobile core network 140. For example, an application in a remote unit 105 (e.g., web browser, media client, telephone and/or Voice-over-Internet-Protocol (“VoIP”) application) may trigger the remote unit 105 to establish a protocol data unit (“PDU”) session (or other data connection) with the mobile core network 140 via the 5G-RAN. The mobile core network 140 then relays traffic between the remote unit 105 and the remote host 155 in the data network 150 using the PDU session. The PDU session represents a logical connection between the remote unit 105 and the User Plane Function (“UPF”) 141. In various embodiments, each PDU session is associated with a different Internet Protocol (“IP”) address.

In order to establish a PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In various embodiments, the remote unit 105 is able to communicate concurrently with both the 3GPP access network 120 and the non-3GPP access network 130. In such embodiments, the remote unit 105 and mobile core network 140 may establish a multi-access connection, such as a Multi Access PDU (“MA PDU”) session, where the multi-access connection comprises a first access path 151 (denoted “Access Path #1”) using the 3GPP access network 120 and a second access path 153 (denoted “Access Path #2”) in the non-3GPP access network 130. As used herein, an “access path” refers to a user-plane connection using a particular access network and may also be referred to as a “data path” of a multiaccess data connection.

When establishing the multi-access data connection, the remote unit 105 may receive a set of traffic steering rules (e.g., ATSSS rules), some of which may refer to a specific QoS parameter. Here, the traffic steering rules may be specific to an access network, specific to a remote unit 105 (e.g., based on a subscription and/or on a roaming status of the remote unit 105), specific to a combination of data network and remote unit 105, or the like. Additionally, the remote unit 105 applies the ATSSS rules after receiving measurement information indicating values for the QoS parameters on each access network. As noted above, the ATSSS rules indicate which access network (i.e., access path) of the MA-PDU session uplink traffic is to be routed.

Examples of ATSSS rules involving QoS parameters include: “Route traffic of App-A to the access with the smallest Loss Rate,” “Route IMS voice traffic to the access with the smallest Delay,” “Route traffic of App-B to 3GPP access, if Delay over 3GPP access is less than 40 ms,” and “Route traffic of App-C to non-3GPP access, if Throughput over non-3GPP access is greater than 1 Mbps.” In one embodiment, the QoS parameters include one or more of: Throughput (e.g., an amount of data passing through the path of the PDU session over the access network), Latency (e.g., an amount of time it takes to communicate data over the path), and Loss Rate (e.g., a rate of data unsuccessfully communicated over the path). In certain embodiments, Jitter (e.g., a delay variance), or other performance parameters may be measured.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. For the multi-access PDU session, the UPF 141 anchors both the first access path 151 and the second access path 153. Note that a PDU Session supports at least one Quality of Service (“QoS”) Flow, identified using a QoS Flow Identifier (“QFI”). In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The cellular base units 121 may be distributed over a geographic region. In certain embodiments, a cellular base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The cellular base units 121 are generally part of a RAN, such as the RAN 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the RAN 120.

The cellular base units 121 may serve a number of remote units 105 within a service area, for example, a cell or a cell sector, via a wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the cellular base units 121. Note that during NR operation on unlicensed spectrum (referred to as “NR-U”), the cellular base unit 121 and the remote unit 105 communicate over unlicensed (i.e., shared) radio spectrum.

In various embodiments, one or more non-3GPP access networks 130 are distributed over a geographic region, where each non-3GPP access network 130 serves a number of remote units 105 with a service area (also referred to as a coverage area). An access point 131 in a non-3GPP access network 130 may communicate directly with one or more remote units 105 by receiving UL communication signals and transmitting DL communication signals to serve the remote units 105 in the time, frequency, and/or spatial domain. As noted above, both DL and UL communication signals are carried over the wireless communication links 133. In some embodiments, the wireless communication links 123 and the wireless communication links 133 may employ different frequencies and/or different communication protocols. In various embodiments, an access point 131 may communicate using unlicensed (i.e., shared) radio spectrum.

In some embodiments, a non-3GPP access network 130 connects to the mobile core network 140 via an interworking function 135. The interworking function 135 provides interworking between a non-3GPP access network 130 and the mobile core network 140, e.g., supporting connectivity via the “N2” and “N3” interfaces. Note that both the 3GPP access network 120 and the interworking function 135 communicate with the AMF 143 using a “N2” interface and with the UPF 141 using a “N3” interface.

In certain embodiments, a non-3GPP access network 130 may be controlled by an operator of the mobile core network 140 and may have direct access to the mobile core network 140. Such a non-3GPP deployment is referred to as a “trusted non-3GPP access network.” A non-3GPP access network 130 is considered as “trusted” when it is operated by the 3GPP operator, or a trusted partner, and supports certain security features, such as strong air-interface encryption. While the interworking function 135 is depicted as being located outside both the non-3GPP access network 130 and the mobile core network 140, in other embodiments the interworking function 135 may be co-located with the non-3GPP access network 130 (e.g., if the non-3GPP access network 130 is a trusted non-3GPP access network) or located within the mobile core network 140.

In one embodiment, the mobile core network 140 is a 5G Core network (“5GC”) or an Evolved Packet Core (“EPC”), which may be coupled to a packet data network 150, such as the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In some embodiments, a Network Data Analytics Function (“NWDAF”) may collect data and create RTT analytics. This is an efficient method but requires analytics information, which predict the RTT with statistical methods, thus, the analytics-based RTT may be different from the RTT measured in real-time. Moreover, the accuracy of the predicted analytics-based RTT may not be sufficient for many use cases, such as using the RTT for taking traffic steering decisions. Further, analytics-based RTT measurements requires the remote unit 105 to support the PMF protocol, which is inefficient compared to QoS monitoring procedures.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

To steer traffic on a multi-access data connection, the remote unit 105 is configured, e.g., by the mobile core network 140, with a set of multiaccess rules 107 for steering traffic via the multiaccess data connection. In one embodiment, the set of multiaccess rules 107 (also referred to as an ATSSS policy) is received during establishment of the multiaccess data connection, for example in a PDU establishment accept message. Note that QoS rules 109 may also be received in the PDU establishment accept message.

For each data flow using the multiaccess data connection, the remote unit 105 identifies an applicable multiaccess rule 107 and routes the traffic to a specific user-plane connection based on the applicable multiaccess rule 107. In various embodiments, the set of multiaccess rules 107 is a prioritized list of rules also having a default rule (e.g., a lowest-priority rule). Multiaccess rules 107 are examined in priority order. In some embodiments, each multiaccess rule 107 has a traffic filter used to determine whether the rule is applicable to a data packet (e.g., of the data flow) to be sent on the multiaccess data connection. A data packet matches a multiaccess rule 107 if the information in the data packet (e.g., protocol, port number, etc.) matches with the corresponding information in the traffic filter of the rule.

While FIG. 1 depicts components of a 5G RAN and a 5G core network, the described embodiments for measuring QoS parameters in a multiaccess data connection apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “UE” is used for the mobile station/remote unit, but it is replaceable by any other remote device, e.g., remote unit, MS, ME, Customer Premise Equipment (“CPE”), etc. Additionally, the term “RAN node” is used for the base station/base unit, but it is replaceable by any other radio access node, e.g., gNB, ng-eNB, eNB, Base Station (“BS”), Access Point (“AP”), Integrated Access-and-Backhaul (“IAB”) node, Radio Head (“RH”), etc. Further, the operations are described mainly in the context of 5G NR. However, the below described solutions/methods are also equally applicable to other mobile communication systems for measuring QoS parameters in a multiaccess data connection.

Disclosed herein are enhancements to the QoS monitoring procedures, so that they can be applied for measuring the RTT in the context of a MA PDU Session, i.e., to measure the RTT between the UE and UPF across multiple access types. In such embodiments, QoS monitoring procedures may be performed over both the 3GPP access network and the non-3GPP access network.

Also disclosed herein are enhancements that enable a UE, which has established a MA PDU Session, to receive information about measurements that were carried out by the network, such as, which access type features the smallest RTT, what is the RTT over 3GPP access, what is the RTT over non-3GPP access, etc. Based on these enhancements, the UE does not carry out its own measurements using the PMF protocol.

Although the text in this disclosure mainly refers to RTT measurements, the method specified is applicable to other types of access network performance measurements, such as Packet Loss Rate (“PLR”) measurements.

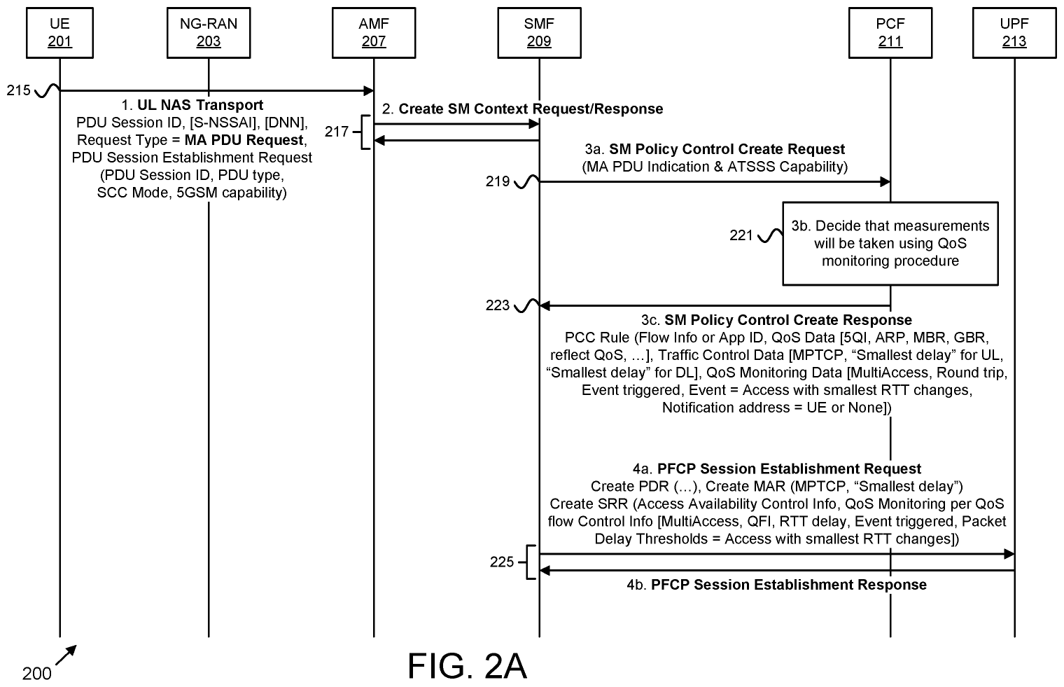

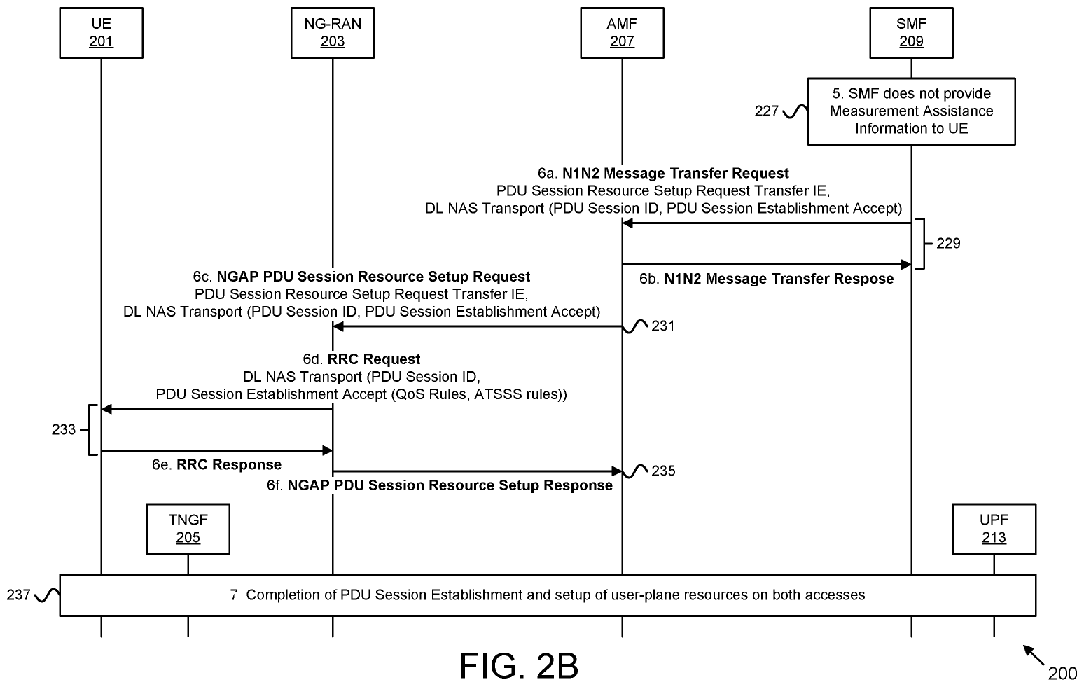

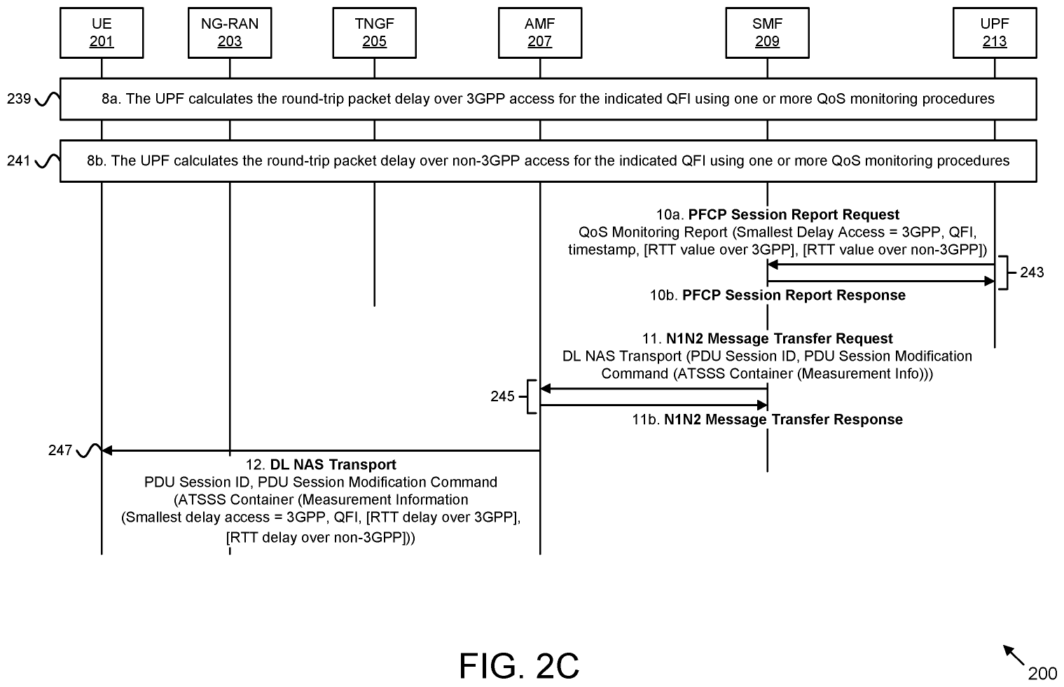

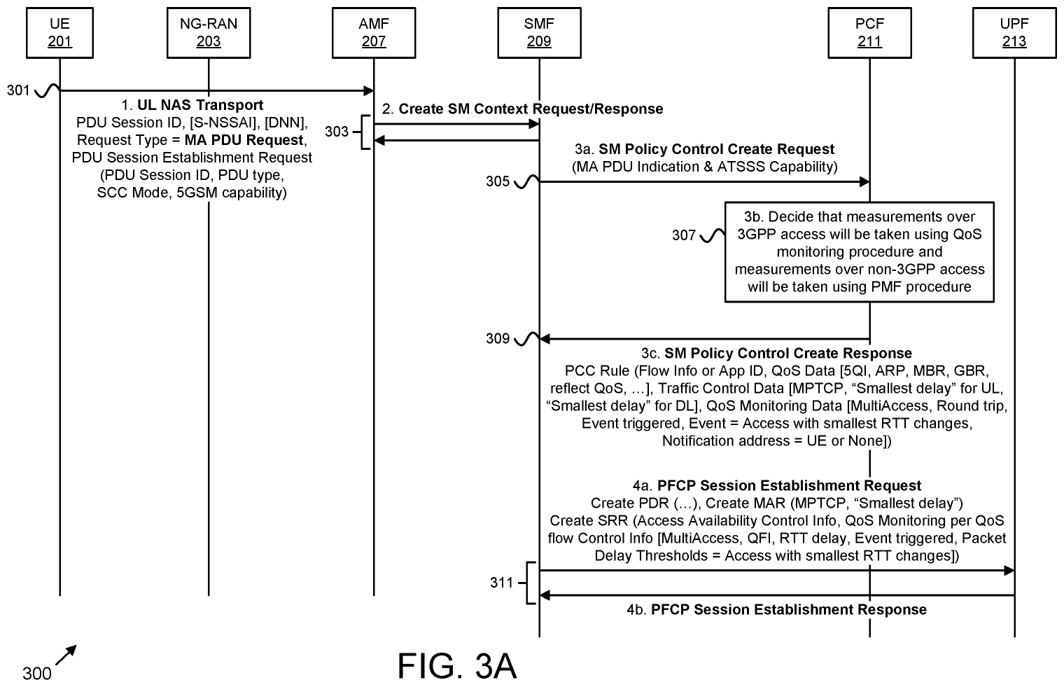

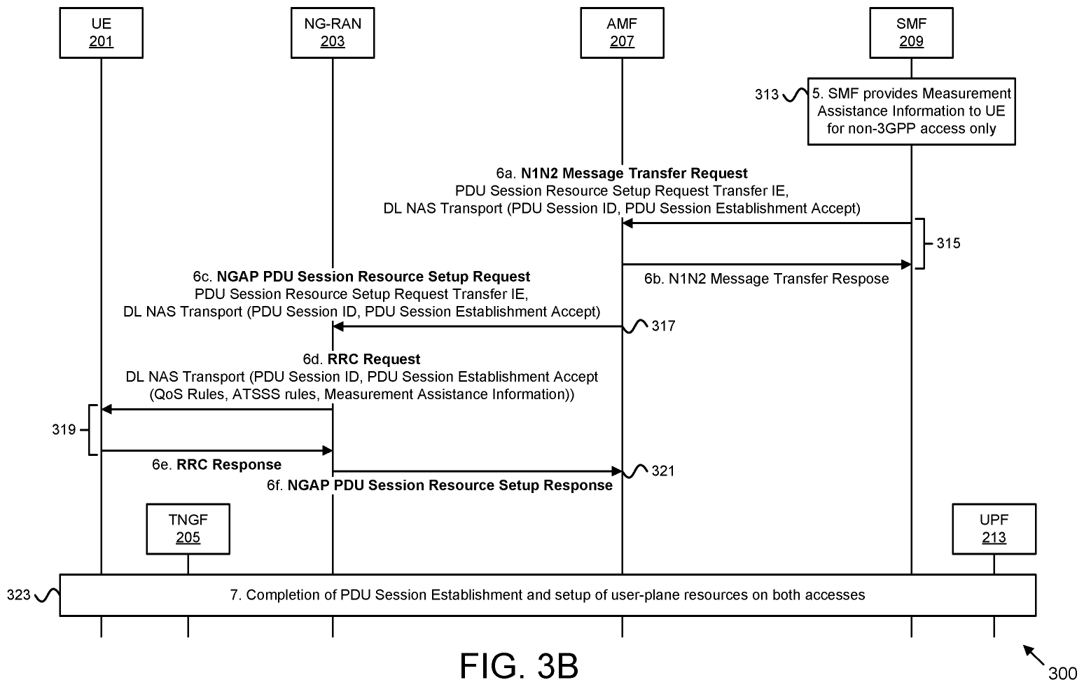

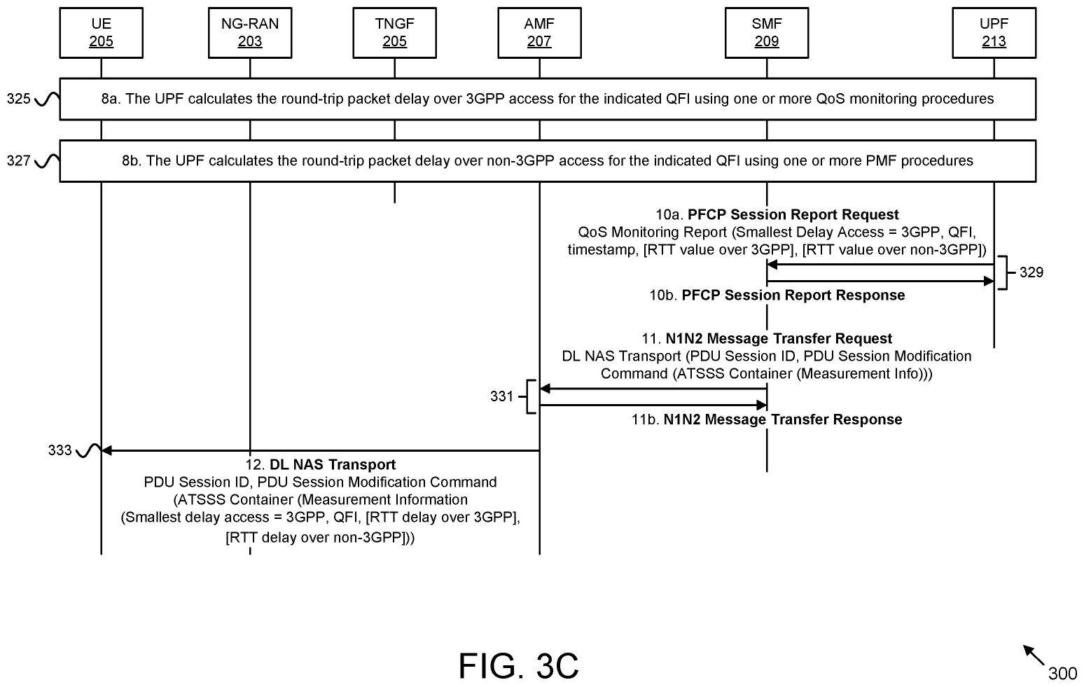

Regarding the impact of the described solutions to different network elements, the following is a summary of the behavior of the UE, the PCF, the SMF, and the PCF. Note that the below behavior is described in greater detail with reference to FIGS. 2A-2C and 3A-3C.

UE: During the establishment of a MA PDU Session, the UE does not receive Measurement Assistance Information. This triggers the UE to refrain from carrying out measurements with the PMF protocol. Instead, the UE awaits to receive a PDU Session Modification Command including information about the measurements performed by the network. The UE then applies this information for taking traffic steering decisions.

PCF: When it receives a Session Management (“SM”) Policy Control Create Request for a MA PDU Session, the PCF decides whether measurements (if needed) should be taken by using the QoS monitoring procedure (and not the existing PMF procedure). To enable measurements with the QoS monitoring procedure, a Policy and Charging Control (“PCC”) rule created by PCF may contain a QosMonitoringData element, which indicates that measurements should be activated on all accesses of the MA PDU Session and that notifications should be provided when certain events are met, such as when the access with the smallest RTT changes.

SMF: The SMF should be able to configure the UPF with the appropriate QoS monitoring information so that the UPF initiates the appropriate measurement procedures over all accesses of the MA PDU Session and the UPF transmits reports to SMF when certain measurement conditions are met (e.g., when a measured RTT exceeds a threshold). In addition, the SMF should be able to initiate a NAS procedure with the UE (e.g., the PDU Session Modification procedure) to send to UE information about the measurements performed by the UPF.

UPF: The UPF should be able to initiate measurements over all accesses of the MA PDU Session by applying the existing QoS monitoring procedures and should be able to transmit reports to SMF when the configured conditions are met.

FIGS. 2A-2C depict a procedure 200 for measuring access network performance of a multiaccess data connection using QoS monitoring procedures, according to embodiments of the disclosure. The procedure 200 involves a UE 201, a NG-RAN 203, an TNGF 205, an AMF 207, a SMF 209, a PCF 211, and a UPF 213. Here, the UE 201 may be one embodiment of the remote unit 105, the NG-RAN 203 may be one embodiment of the 3GPP access network 120, the TNGF 205 may be one embodiment of an interworking function 135 supporting a non-3GPP access network 130. Further, the AMF 207 may be one embodiment of the AMF 143, the SMF 209 may be one embodiment of the SMF 145, the PCF 211 may be one embodiment of the PCF 147, and the UPF 213 may be one embodiment of the UPF 141. Note here that the AMF 207, SMF 209, PCF 211 and UPF 213 are assumed to be part of a 5G core network (“5G”).

According to embodiments of the first solution, the UE 201 supports ATSSS and both the NG-RAN 203 and the non-3GPP access network support QoS monitoring procedures. The PCF 211 decides that access network performance measurements should be taken by using the QoS monitoring procedures. Thus, the UPF 213 measures the access network performance (e.g., RTT) over each user-plane path by using the existing procedures for QoS monitoring and provides the measured values to the UE 201. Accordingly, the UE 201 distributes traffic in the uplink (“UL”) direction across the NG-RAN 203 and the non-3GPP access network based on ATSSS rules provisioned by the SMF 209 and the UPF 213 distributes traffic in the downlink (“DL”) direction across the NG-RAN 203 and the non-3GPP access network based on corresponding N4 rules.

Starting on FIG. 2A, the procedure 200 begins at Step 1, where the UE 201 sends an UL NAS Transport message that encapsulates a PDU Session Establishment Request to request a MA PDU session (see messaging 215). As depicted, the parameters of the PDU Session Establishment Request may include a PDU Session ID, a PDU type, the Session and Service Continuity (“SSC”) mode, and a 5GS SM (“5GSM”) capability information element (“IE”).

At Step 2, the AMF 207 that receives the UL NAS Transport message selects an SMF (i.e., the SMF 209) and creates a new Session Management (“SM”) context in the SMF 209, which includes sending a Create SM Context Request message to the SMF 209 and receiving a Create SM Context Response message (see messaging 217) from the SMF 209.

At Step 3a, the SMF 209 selects a PCF 211 and sends an SM Policy Control Create Request message to the PCF 211, to request policy for the requested MA PDU Session (see messaging 219). As depicted, the SM Policy Control Create Request message contains a MA PDU Indication (i.e., indicating that requested session should support multiaccess) and the ATSSS capabilities of the UE 201.

At Step 3b, the PCF 211 creates PCC rules containing traffic control data which specifies how the traffic of the MA PDU Session should be distributed across the access paths of the MA PDU Session (e.g., access paths 151 and 153). It is assumed that the traffic control data in at least one PCC rule requires a QoS parameter to be measured on each access path of the MA PDU Session. For example, when the traffic control data specifies that the traffic should distributed based on the “Smallest delay” steering mode, then the PCC rule requires the RTT to be measured on each access path of the MA PDU Session for enforcing the PCC rule.

In the case where the PCC rules require at least one QoS parameter to be measured on each access path of the MA PDU Session, the PCF 211 decides how the at least one QoS parameter should be measured. The QoS parameter can be measured either by applying the existing procedures using the PMF protocol, or by applying the enhanced QoS monitoring procedures for multiaccess described herein. In the depicted embodiments, it is assumed that the PCF 211 decides that measurements should be taken by using the QoS monitoring procedures (see block 221).

At Step 3c, the PCF 211 sends the created PCC rules to SMF 209 (see messaging 223). Each PCC rule that requires a QoS parameter to be measured on each access path of the MA PDU Session contains also a QoS Monitoring Data element, which comprises:
A MultiAccess indication, which indicates that QoS monitoring on each access path of the MA PDU Session is required;
The QoS parameter that should be monitored (or measured), e.g., Round Trip Time (“RTT”) or Packet Loss Rate (“PLR”);
The events that should be reported, e.g., when the measured RTT on one access exceeds a threshold, or when the access with the smallest measured RTT changes, etc.
Optionally, a notification address that specifies the receiver of the event reports. In the scenario discussed here, we assume that the notification address is not used.

The inclusion of the QoS Monitoring Data element in at least one PCC rule is an implicit indication that the PCF 211 decided that measurements should be taken by using the QoS monitoring procedures. An explicit indication may also be provided by the PCF 211 in addition to the QoS Monitoring Data element.

At Step 4, after receiving the PCC rules, the SMF 209 selects a UPF 213 and establishes a Packet Forwarding Control Protocol (“PFCP”) Session (i.e., a N4 Session) with the UPF 213 (see messaging 225). In the PFCP Session Establishment Request message the SMF 209 includes QoS monitoring per QoS flow control information, which contains:
A MultiAccess indication, which indicates that QoS monitoring on each access path of the MA PDU Session is required;
The QoS parameter that should be monitored (or measured), e.g., RTT or PLR;
The events that should be reported, e.g., when the measured RTT on one access exceeds a threshold, or when the access with the smallest measured RTT changes;
The identifier of each QoS flow over which the QoS parameter should be measured.

Continuing on FIG. 2B, at Step 5, the SMF 209 builds a PDU Session Establishment Accept message to send to UE 201. In this message, however, the SMF 209 does not include Measurement Assistance Information (“MAI”) because the UE 201 is not to initiate measurements (see block 227). According to the first solution, all measurements will be conducted by the UPF 213 using the QoS monitoring procedures. Accordingly, the SMF 209 creates the traffic steering rules based on the received PCC rules.

At Step 6, the SMF 209 sends the PDU Session Establishment Accept message to UE 201, according with the currently specified procedures. The SMF 209 includes traffic steering rules (e.g., ATSSS rules) in the PDU Session Establishment Accept message, which are need by the UE 201 for distributing the uplink traffic across the access paths of the MA PDU Session.

Specifically, at Step 6a the SMF 209 sends to the AMF 207 an N1N2 Message Transfer Request message with a DL NAS transport container containing the PDU Session ID and the PDU Session Establishment Accept message, and at Step 6b the AMF 207 sends an N1N2 Message Transfer Response (see messaging 229).

At Step 6c the AMF 207 sends to the NG-RAN 203 a Next Generation Application Protocol (“NGAP”) PDU Session Resource Setup Request message with the DL NAS transport container containing the PDU Session ID and the PDU Session Establishment Accept message (see messaging 231).

At Step 6d the NG-RAN 203 sends to the UE 201 a Radio Resource Control (“RRC”) Request message with the DL NAS transport container containing the PDU Session ID and the PDU Session Establishment Accept message, and at Step 6e the UE 201 sends an RRC Response message (see messaging 233). Moreover, at Step 6f the NG-RAN 203 sends an NGAP PDU Session Resource Setup Response message (see messaging 235).

At Step 7, further messages are exchanged between the UE 201, the NG-RAN 203, the TNGF 205, the AMF 207, the SMF 209 and the UPF 213 until the PDU Session establishment procedure is completed (see block 237). In various embodiments, the exchanged messages in Step 7 are based on the current 3GPP specifications. While the depicted embodiments involves the TNGF 205 that supports a trusted non-3GPP access network, in other embodiments of the procedure 200, the TNGF 205 may be replaced with a N3IWF that supports an untrusted non-3GPP access network.

Continuing on FIG. 2C, at Step 8a, the UPF 213 calculates the round-trip packet delay (i.e., RTT) over the 3GPP access (i.e., NG-RAN 203) for the indicated QFI using the existing QoS monitoring procedures, e.g., as specified in the 3GPP specifications (see block 239). At Step 8b, the UPF 213 calculates the round-trip packet delay (i.e., RTT) over the non-3GPP access for the indicated QFI, e.g., using one or more QoS monitoring procedures (see block 241).

At Step 10, when the UPF 213 determines that an event should be reported (e.g., when the access with the smallest measured RTT changes), the UPF 213 sends a PFCP Session Report Request to SMF 209 which includes a QoS Monitoring Report element (see messaging 243). In some embodiments, the QoS Monitoring Report element includes:
The reported event, e.g., the new access that has the smallest measured RTT, or the measured RTT that exceeds a threshold, etc.
The QFI associated with the event and the measured QoS parameter;
A timestamp;
Other information (optional), such as the RTT value measured over 3GPP access and the RTT value measured over non-3GPP access.

At Step 11, after the SMF 209 receives the report from UPF 213, the SMF 209 builds a PDU Session Modification Command to be sent to the UE 201. The PDU Session Modification Command contains Measurement Information in the ATSSS Container element. The SMF 209 derives the Measurement Information from the information in the PFCP Session Report Request message and it can contain all the components specified in the previous step.

Consequently, the SMF 209 sends to AMF 207 an N1N2 Message Transfer Request, which encapsulates the PDU Session Modification Command containing the Measurement Information (see messaging 245). Note here that the Measurement Information containing reported values measured by the UPF is not to be confused with the Measurement Assistance Information (“MAI”) which is sent prior to PMF procedures.

At Step 12, the AMF 207 forwards the PDU Session Modification Command to the UE 201 (see messaging 247), and the UE 201 applies the received Measurement Information for evaluating the traffic steering rules and for determining how to distribute the uplink traffic across the access paths of the MA PDU Session. While in the depicted embodiment the PDU Session Modification Command is sent over the NG-RAN 203, in other embodiments the PDU Session Modification Command is sent over the non-3GPP access.

FIGS. 3A-3C depict a procedure 300 for measuring access network performance of a multiaccess data connection using both QoS monitoring procedures and PMF procedures, according to embodiments of the disclosure. The procedure 300 involves the UE 201, the NG-RAN 203, the TNGF 205, the AMF 207, the SMF 209, the PCF 211, and the UPF 213. Here, it is assumed that the UPF 213 and the UE 201 implement a PMF.

According to embodiments of the second solution, the UE 201 supports ATSSS and only the 3GPP access network (i.e., NG-RAN 203) supports QoS monitoring procedures. The PCF 211 decides that access network performance measurements should be taken for the NG-RAN 203 by using the QoS monitoring procedures. Thus, the UPF 213 measures access network performance (e.g., RTT) over the user-plane path in the 3GPP access network by using the existing procedures for QoS monitoring and measures access network performance over the user-plane path in the non-3GPP access network by using PMF procedures. The UPF 213 provides the measured values to the UE 201. Accordingly, the UE 201 distributes traffic in the uplink (“UL”) direction across the NG-RAN 203 and the non-3GPP access network based on ATSSS rules provisioned by the SMF 209 and the UPF 213 distributes traffic in the downlink (“DL”) direction across the NG-RAN 203 and the non-3GPP access network based on corresponding N4 rules.

Starting on FIG. 3A, the procedure 300 begins at Step 1, where the UE 201 sends an UL NAS Transport message that encapsulates a PDU Session Establishment Request to request a MA PDU session (see messaging 301). As depicted, the parameters of the PDU Session Establishment Request may include a PDU Session ID, a PDU type, the SSC mode, and a 5GSM capability IE.

At Step 2, the AMF 207 that receives the UL NAS Transport message selects an SMF (i.e., the SMF 209) and creates a new Session Management (“SM”) context in the SMF 209, which includes sending a Create SM Context Request message to the SMF 209 and receiving a Create SM Context Response message (see messaging 303) from the SMF 209.

At Step 3a, the SMF 209 selects a PCF 211 and sends an SM Policy Control Create Request message to the PCF 211, to request policy for the requested MA PDU Session (see messaging 305). As depicted, the SM Policy Control Create Request message contains a MA PDU Indication (i.e., indicating that requested session should support multiaccess) and the ATSSS capabilities of the UE 201.

At Step 3b, the PCF 211 creates PCC rules containing traffic control data which specifies how the traffic of the MA PDU Session should be distributed across the access paths of the MA PDU Session. It is assumed that the traffic control data in at least one PCC rule requires a QoS parameter to be measured on each access path of the MA PDU Session. For example, when the traffic control data specifies that the traffic should distributed based on the “Smallest delay” steering mode, then the PCC rule requires the RTT to be measured on each access path of the MA PDU Session for enforcing the PCC rule.

In the case where the PCC rules require at least one QoS parameter to be measured on each access path of the MA PDU Session, the PCF 211 decides how the at least one QoS parameter should be measured. The QoS parameter can be measured either by applying the existing procedures using the PMF protocol on the non-3GPP access network, or by applying the enhanced QoS monitoring procedures for multiaccess on the 3GPP access network. In the depicted embodiments, it is assumed that the PCF 211 decides that measurements on the 3GPP access network should be taken by using the QoS monitoring procedures and that measurements on the non-3GPP access network should be taken by using the PMF protocol procedures (see block 307).

At Step 3c, the PCF 211 sends the created PCC rules to SMF 209 (see messaging 309). Each PCC rule that requires a QoS parameter to be measured on each access path of the MA PDU Session contains also a QoS Monitoring Data element, as described above. Accordingly, the SMF 209 creates the traffic steering rules based on the received PCC rules.

In one embodiment, the inclusion of the QoS Monitoring Data element in at least one PCC rule is an implicit indication that the PCF 211 decided that measurements should be taken by using the QoS monitoring procedures. In another embodiment, an explicit indication may be provided by the PCF 211 in addition to the QoS Monitoring Data element.

At Step 4, after receiving the PCC rules, the SMF 209 selects a UPF 213 and establishes a PFCP Session (i.e., a N4 Session) with the UPF 213 (see messaging 311). In the PFCP Session Establishment Request message the SMF 209 includes QoS monitoring per QoS flow control information, as described above.

Continuing on FIG. 3B, at Step 5, the SMF 209 builds a PDU Session Establishment Accept message to send to UE 201. In this message, the SMF 209 includes Measurement Assistance Information (“MAI”) because the UE 201 is to initiate measurements, e.g., on the non-3GPP access network (see block 313).

At Step 6, the SMF 209 sends the PDU Session Establishment Accept message to UE 201, according with the currently specified procedures. The SMF 209 includes QoS rules, traffic steering rules (e.g., ATSSS rules), and the MAI in the PDU Session Establishment Accept message, which are need by the UE 201 for distributing the uplink traffic across the access paths of the MA PDU Session. 3GPP specification define the MAI as containing:
the IP address of the UPF implementing the PMF protocol;
one or more UDP port numbers to be used over the 3GPP access for taking PMF measurements via one or more QoS flows; and
one or more UDP port numbers to be used over the non-3GPP access for taking PMF measurements via one or more QoS flows

In the second solution, the MAI sent from the SMF 209 to UE 201 does not include the second element (i.e., the MAI only includes the IP address of the UPF implementing the PMF protocol and one or more UDP port numbers to be used over the non-3GPP access for taking PMF measurements via one or more QoS flows). Accordingly, the MAI indicates that the UE 201 is to take PMF measurements only over the non-3GPP access.

Specifically, at Step 6a the SMF 209 sends to the AMF 207 an N1N2 Message Transfer Request message with a DL NAS transport container containing the PDU Session ID and the PDU Session Establishment Accept message, and at Step 6b the AMF 207 sends an N1N2 Message Transfer Response (see messaging 315).

At Step 6c the AMF 207 sends to the NG-RAN 203 an NGAP PDU Session Resource Setup Request message with the DL NAS transport container containing the PDU Session ID and the PDU Session Establishment Accept message (see messaging 317).

At Step 6d the NG-RAN 203 sends to the UE 201 an RRC Request message with the DL NAS transport container containing the PDU Session ID and the PDU Session Establishment Accept message, and at Step 6e the UE 201 sends an RRC Response message (see messaging 319). Moreover, at Step 6f the NG-RAN 203 sends an NGAP PDU Session Resource Setup Response message (see messaging 321).

At Step 7, further messages are exchanged between the UE 201, the NG-RAN 203, the TNGF 205, the AMF 207, the SMF 209 and the UPF 213 until the PDU Session establishment procedure is completed (see block 323). In various embodiments, the exchanged messages in Step 7 are based on the current 3GPP specifications. While the depicted embodiments involve the TNGF 205 that supports a trusted non-3GPP access network, in other embodiments of the procedure 200, the TNGF 205 may be replaced with a N3IWF that supports an untrusted non-3GPP access network.

Continuing on FIG. 3C, at Step 8a, the UPF 213 calculates the round-trip packet delay (i.e., RTT) over the 3GPP access (i.e., NG-RAN 203) for the indicated QFI using the existing QoS monitoring procedures, e.g., as specified in the 3GPP specifications (see block 325). At Step 8b, the UPF 213 calculates the round-trip packet delay (i.e., RTT) over the non-3GPP access for the indicated QFI, e.g., using one or more PMF protocol procedures (see block 327).

At Step 10, when the UPF 213 determines that an event should be reported (e.g., when the access with the smallest measured RTT changes), the UPF 213 sends a PFCP Session Report Request to SMF 209 which includes a QoS Monitoring Report element, as described above (see messaging 329). While described as a “QoS Monitoring Report,” this element may include access network performance measurements for the non-3GPP access network that were measured using the PMF protocol procedures.

At Step 11, after the SMF 209 receives the report from UPF 213, the SMF 209 builds a PDU Session Modification Command to be sent to the UE 201. The PDU Session Modification Command contains Measurement Information in the ATSSS Container element. The SMF 209 derives the Measurement Information from the information in the PFCP Session Report Request message and it can contain all the components specified in the previous step.

Consequently, the SMF 209 sends to AMF 207 an N1N2 Message Transfer Request, which encapsulates the PDU Session Modification Command containing the Measurement Information (see messaging 331). Note here that the Measurement Information containing reported values measured by the UPF 213 is not to be confused with the Measurement Assistance Information (“MAI”).

At Step 12, the AMF 207 forwards the PDU Session Modification Command to the UE 201 (see messaging 333), and the UE 201 applies the received Measurement Information for evaluating the traffic steering rules and for determining how to distribute the uplink traffic across the access paths of the MA PDU Session. While in the depicted embodiment the PDU Session Modification Command is sent over the NG-RAN 203, in other embodiments the PDU Session Modification Command is sent over the non-3GPP access.

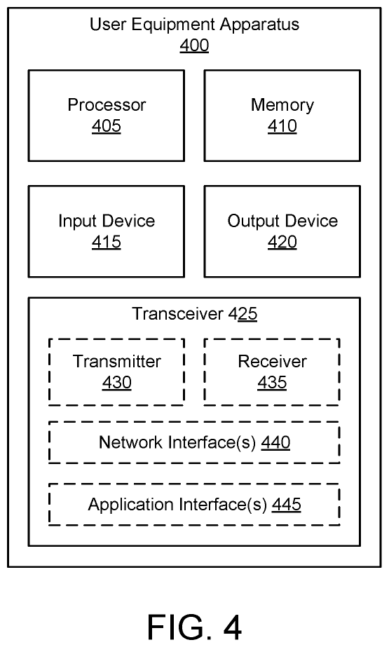

FIG. 4 depicts one embodiment of a user equipment apparatus 400 that may be used for measuring QoS parameters in a multiaccess data connection, according to embodiments of the disclosure. The user equipment apparatus 400 may be one embodiment of the remote unit 105 and/or the UE 201. Furthermore, the user equipment apparatus 400 may include a processor 405, a memory 410, an input device 415, an output device 420, a transceiver 425.

In some embodiments, the input device 415 and the output device 420 are combined into a single device, such as a touchscreen. In certain embodiments, the user equipment apparatus 400 may not include any input device 415 and/or output device 420. In various embodiments, the user equipment apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. In some embodiments, the transceiver 425 communicates with one or more cells (or wireless coverage areas) supported by one or more cellular base units 121, and/or access points 131. In various embodiments, the transceiver 425 is operable on unlicensed spectrum. Moreover, the transceiver 425 may include multiple UE panels supporting one or more beams. Additionally, the transceiver 425 may support at least one network interface 440 and/or application interface 445. The application interface(s) 445 may support one or more APIs. The network interface(s) 440 may support 3GPP reference points, such as Uu, N1, PC5, etc. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425.

In various embodiments, the processor 405 controls the user equipment apparatus 400 to implement the above described UE behaviors. In certain embodiments, the processor 405 may include an application processor (also known as “main processor”) which manages application-domain and operating system (“OS”) functions and a baseband processor (also known as “baseband radio processor”) which manages radio functions.

In various embodiments, the transceiver 425 communicates (i.e., using a radio interface) with a mobile communication network via a plurality of access networks. The processor 405 sends a first message to establish a multiaccess data connection with the mobile communication network, where the multiaccess data connection includes a set of access networks (i.e., from the plurality of access networks). Via the transceiver, the processor 405 receives a second message that accepts the establishment of the multiaccess data connection and receives a third message, where the second message includes a set of traffic routing rules (e.g., ATSSS rules) and the third message includes measurement information for the set of access networks of the multiaccess data connection. The processor 405 applies the measurement information and the set of traffic routing rules to determine how to transmit data traffic across the set of access networks of the multiaccess data connection.

In some embodiments, the third message includes a PDU Session Modification Command. In some embodiments, the received measurement information is obtained by a UPF in the mobile communication network using at least one QoS monitoring procedure, where the measurement information includes measurements for the at least one QoS parameter for each access network in the set of access networks.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to establishing a multipath unicast link and/or mobile operation. For example, the memory 410 may store various parameters, panel/beam configurations, resource assignments, policies, and the like as described above. In certain embodiments, the memory 410 also stores program code and related data, such as an operating system or other controller algorithms operating on the apparatus 400.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, the output device 420 may be located near the input device 415.

The transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

The transceiver 425 includes at least transmitter 430 and at least one receiver 435. One or more transmitters 430 may be used to provide UL communication signals to a cellular base unit 121 and/or an access point 131, such as the UL transmissions described herein. Similarly, one or more receivers 435 may be used to receive DL communication signals from a cellular base unit 121 and/or an access point 131, as described herein. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

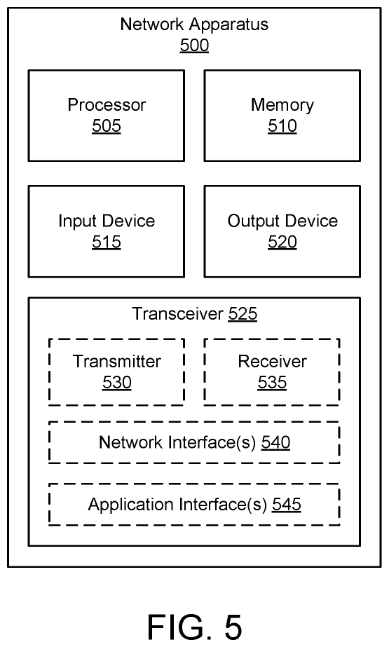

FIG. 5 depicts one embodiment of a network apparatus 500 that may be used for measuring QoS parameters in a multiaccess data connection, according to embodiments of the disclosure. In some embodiments, the network apparatus 500 may implement a UPF. In other embodiments, the network apparatus 500 may implement an SMF. In further embodiments, the network apparatus 500 may implement a PCF. Furthermore, network apparatus 500 may include a processor 505, a memory 510, an input device 515, an output device 520, a transceiver 525.

In some embodiments, the input device 515 and the output device 520 are combined into a single device, such as a touchscreen. In certain embodiments, the network apparatus 500 may not include any input device 515 and/or output device 520. In various embodiments, the network apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 105. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a CPU, a GPU, an auxiliary processing unit, a FPGA, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the network apparatus 500 is a RAN node (e.g., gNB) that communicates with one or more UEs, as described herein. In such embodiments, the processor 505 controls the network apparatus 500 to perform the above described RAN behaviors. When operating as a RAN node, the processor 505 may include an application processor (also known as “main processor”) which manages application-domain and operating system (“OS”) functions and a baseband processor (also known as “baseband radio processor”) which manages radio functions.

In various embodiments, the network apparatus 500 is a UPF (e.g., the UPF 141 and/or UPF 213) that communicates with one or more NFs in a mobile communication network (e.g., via a transceiver 525 and/or network interface 540), as described herein. In such embodiments, the processor 505 controls the network apparatus 500 to perform the above described UPF behaviors.

In some embodiments, the processor 505 receives a request from the SMF to establish a multiaccess connection for the UE, the multiaccess connection including a set of access networks, where the request includes a plurality of reporting events and QoS monitoring information indicating that at least one QoS monitoring procedure is to be used for taking measurements for at least one QoS parameter (e.g., RTT, PLR, etc.) on each access network in the set of access networks. The processor 505 initiates at least one QoS monitoring procedure for taking measurements for the at least one QoS parameter on each access network in the set of access networks.

In some embodiments, the processor 505 determines that a first reporting event in the plurality of reporting events is fulfilled, e.g., based on the measurements, and sends an event report to the SMF, the event report including information about the first reporting event. In such embodiments, the information about the first reporting event is based on the measurements for the 20) at least one QoS parameter on each access network in the set of access networks.

In certain embodiments, determining that the first reporting event is fulfilled may include determining that an access network (i.e., a data path of the multiaccess connection) with a smallest RTT has changed, where the event report indicates which access network has the smallest RTT. In other embodiments, determining that the first reporting event is fulfilled may include determining that a RTT for a first access network exceeds a threshold value. In further embodiments, the event report may include a RTT value for each access network in the set of access networks.

In certain embodiments, the processor 505 calculates a packet loss rate based on the measurements. In such embodiments, determining that the first reporting event is fulfilled includes determining that a packet loss rate for a first access network exceeds a threshold value. In some embodiments, the multiaccess connection includes a set of QoS flows, where the QoS monitoring information includes a first identifier indicating a first QoS flow in the set of QoS flows over which the measurements for the at least one QoS parameter are to be taken.

In various embodiments, the network apparatus 500 is a SMF (e.g., SMF 145 and/or SMF 209) that communicates with one or more NFs in a mobile communication network (e.g., via a transceiver 525 and/or network interface 540), as described herein. In such embodiments, the processor 505 controls the network apparatus 500 to perform the above described SMF behaviors.

In some embodiments, the processor 505 receives, from the UE, a first message to establish a multiaccess data connection and sends, to the UPF, a request to establish a multiaccess connection for the UE, where the multiaccess data connection includes a set of access networks and where the request includes a plurality of reporting events and QoS monitoring information indicating that at least on QoS monitoring procedure is to be used for taking measurements for at least one QoS parameter (e.g., RTT, PLR, etc.) on each access network in the set of access network (i.e., on each data path of the multiaccess connection).

The processor 505 sends, to the UE, a second message that accepts the establishment of the multiaccess data connection and receives, from the UPF, an event report including information about a first reporting event, where the second message including a set of traffic routing rules (e.g., ATSSS rules) and where the information about the first reporting event is based on measurements for the at least one QoS parameter on each access network in the set of access networks. The processor 505 sends, to the UE, a third message that contains measurement information derived from the received event report.

In some embodiments, sending the third message includes sending a PDU Session Modification Command to the UE. In some embodiments, the second message indicates to the UE that measurements are to be provided by the network. In some embodiments, the first reporting event indicates that an access network with a smallest RTT has changed. In such embodiments, both the report and the third message indicate which access network has the smallest RTT. In certain embodiments, both the report and the third message further include a RTT value for each access network in the set of access networks.

In some embodiments, the processor 505 further sends a policy request to a PCF in the mobile communication network and receives a policy response that includes the plurality of reporting events and the QoS monitoring information for the multiaccess data connection. In such embodiments, the policy response may further include an indication that at least one QoS monitoring procedure is to be used for taking measurements on each access network of the multiaccess data connection.

In various embodiments, the network apparatus 500 is a PCF (e.g., PCF 147 and/or PCF 211) that communicates with one or more NFs in a mobile communication network (e.g., via a transceiver 525 and/or network interface 540), as described herein. In such embodiments, the processor 505 controls the network apparatus 500 to perform the above described PCF behaviors.

In some embodiments, the processor 505 receives, e.g., from an SMF, a policy request for a requested multiaccess data connection that includes a set of access networks and generates a set of rules (e.g., PCC rules) indicating how data traffic of the multiaccess data connection is to be routed across the set of access networks. The processor 505 determines a plurality of reporting events and at least one QoS parameter (e.g., RTT, PLR, etc.) to be measured on each access network in the set of access networks and sends, e.g., to the SMF, a policy response that includes the set of rules, the plurality of reporting events and the at least one QoS parameter.

In some embodiments, the policy response includes an indication that at least one QoS monitoring procedure is to be used to take measurements on each access network of the multiaccess data connection. In some embodiments, at least one PCC rule in the set of rules contains a QoS monitoring data element that indicates that at least one QoS monitoring procedure for taking measurements is to be activated for all access networks of the multiaccess data connection and indicates corresponding reporting events.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to establishing a multipath unicast link and/or mobile operation. For example, the memory 510 may store parameters, configurations, resource assignments, policies, and the like, as described above. In certain embodiments, the memory 510 also stores program code and related data, such as an operating system or other controller algorithms operating on the apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the network apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 includes at least transmitter 530 and at least one receiver 535. One or more transmitters 530 may be used to communicate with the UE, as described herein. Similarly, one or more receivers 535 may be used to communicate with network functions in the PLMN and/or RAN, as described herein. Although only one transmitter 530 and one receiver 535 are illustrated, the network apparatus 500 may have any suitable number of transmitters 530 and receivers 535. Further, the transmitter(s) 530 and the receiver(s) 535 may be any suitable type of transmitters and receivers.

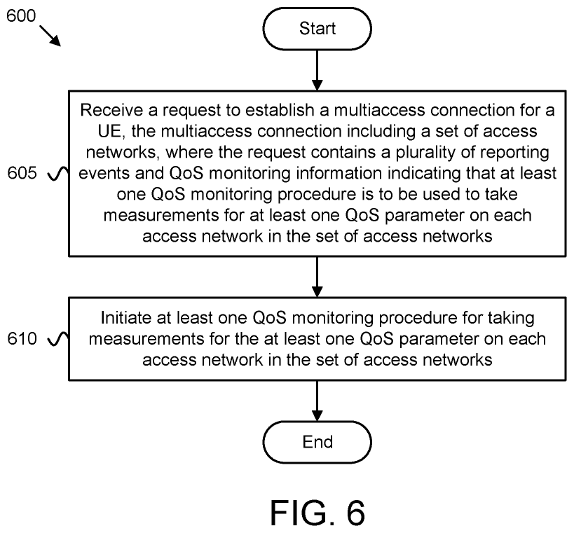

FIG. 6 depicts one embodiment of a method 600 for measuring QoS parameters in a multiaccess data connection, according to embodiments of the disclosure. In various embodiments, the method 600 is performed by a user plane function, such as the UPF 141, the UPF 213, and/or the network apparatus 500, as described above. In some embodiments, the method 600 is performed by a processor, such as a microcontroller, a microprocessor, a CPU, a GPU, an auxiliary processing unit, a FPGA, or the like.

The method 600 begins and receives 605, e.g., from an SMF, a request to establish a multiaccess connection for a UE, where the multiaccess connection includes a set of access networks. Here, the request contains a plurality of reporting events and QoS monitoring information indicating that at least one QoS monitoring procedure is to be used to take measurements for at least one QoS parameter (e.g., RTT, PLR, etc.) on each access network in the set of access networks. The method 600 includes initiating 610 at least one QoS monitoring procedure for taking measurements for the at least one QoS parameter on each access network in the set of access networks. The method 600 ends.

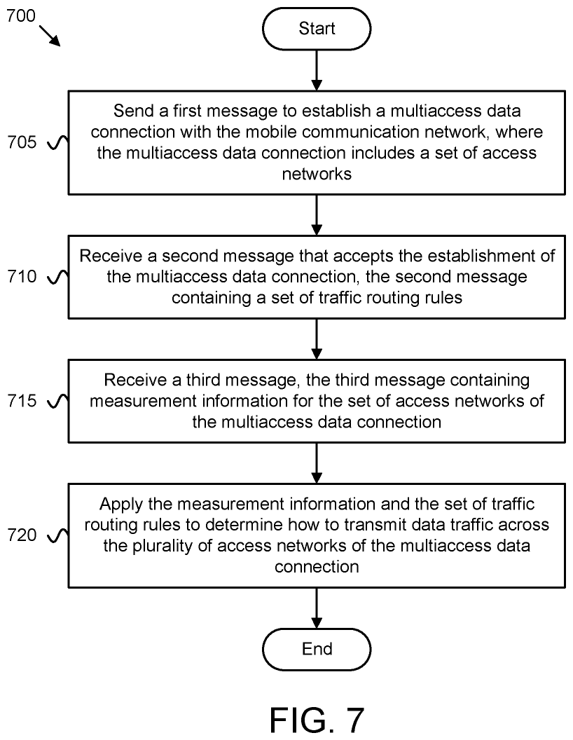

FIG. 7 depicts one embodiment of a method 700 for measuring QoS parameters in a multiaccess data connection, according to embodiments of the disclosure. In various embodiments, the method 700 is performed by a communication device, such as the remote unit 105, the UE 201, and/or the user equipment apparatus 400, as described above. In some embodiments, the method 700 is performed by a processor, such as a microcontroller, a microprocessor, a CPU, a GPU, an auxiliary processing unit, a FPGA, or the like.

The method 700 begins and sends 705 a first message to establish a multiaccess data connection with the mobile communication network, where the multiaccess data connection includes a set of access networks. The method 700 includes receiving 710 a second message that accepts the establishment of the multiaccess data connection, the second message contains a set of traffic routing rules (e.g., ATSSS rules). The method 700 includes receiving 715 a third message (e.g., a PDU Session Modification Command), where the third message contains measurement information for the set of access networks of the multiaccess data connection. The method 700 includes applying 720 the measurement information and the set of traffic routing rules to determine how to transmit data traffic across the plurality of access networks of the multiaccess data connection. The method 700 ends.

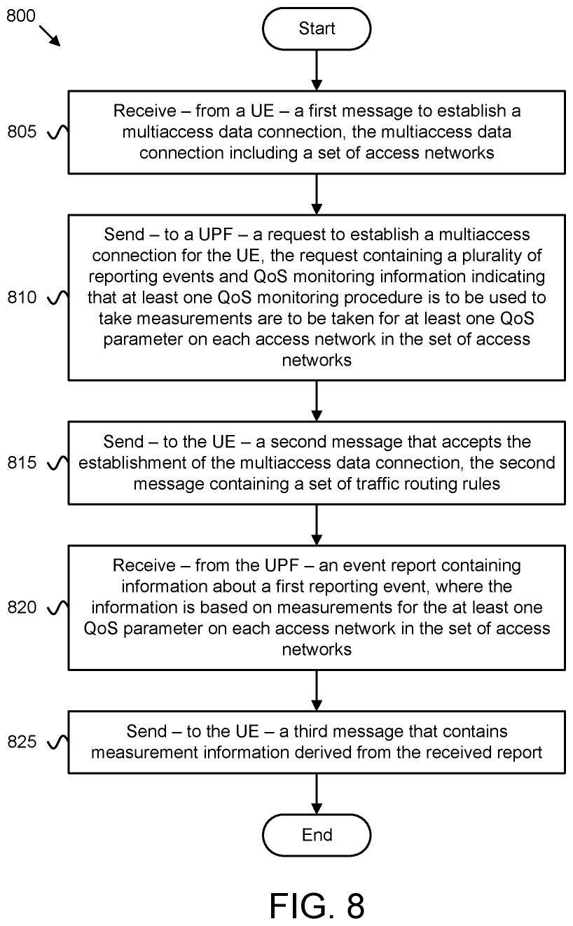

FIG. 8 depicts one embodiment of a method 800 for measuring QoS parameters in a multiaccess data connection, according to embodiments of the disclosure. In various embodiments, the method 800 is performed by a session management function, such as the SMF 145, the SMF 209, and/or the network apparatus 500, as described above. In some embodiments, the method 800 is performed by a processor, such as a microcontroller, a microprocessor, a CPU, a GPU, an auxiliary processing unit, a FPGA, or the like.

The method 800 begins and receives 805, from a UE, a first message to establish a multiaccess data connection, where the multiaccess data connection includes a set of access networks. The method 800 includes sending 810, to a UPF, a request to establish a multiaccess connection for the UE, where the request contains a plurality of reporting events and QoS monitoring information indicating that at least one QoS monitoring procedure is to be used to take measurements are to be taken for at least one QoS parameter (e.g., RTT, PLR, etc.) on each access network in the set of access networks. The method 800 includes sending 815, to the UE, a second message that accepts the establishment of the multiaccess data connection, where the second message contains a set of traffic routing rules (e.g., ATSSS rules). The method 800 includes receiving 820, from the UPF, an event report comprising information about a first reporting event, where the information is based on measurements for the at least one QoS parameter on each access network in the set of access networks. The method 800 includes sending 825, to the UE, a third message (e.g., a PDU Session Modification Command) that contains measurement information derived from the received event report. The method 800 ends

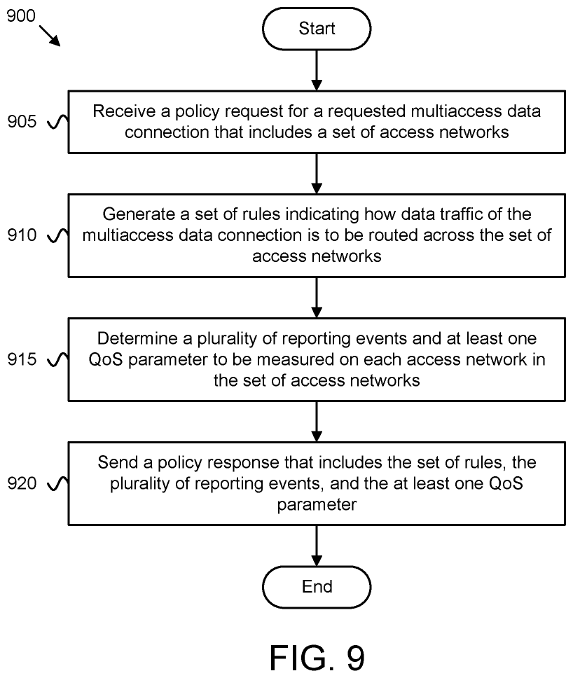

FIG. 9 depicts one embodiment of a method 900 for measuring QoS parameters in a multiaccess data connection, according to embodiments of the disclosure. In various embodiments, the method 900 is performed by a policy control function, such as the PCF 147, the PCF 211, and/or the network apparatus 500, as described above. In some embodiments, the method 900 is performed by a processor, such as a microcontroller, a microprocessor, a CPU, a GPU, an auxiliary processing unit, a FPGA, or the like.

The method 900 begins and receives 905, e.g., from a SMF, a policy request for a requested multiaccess data connection that includes a set of access networks. The method 900 includes generating 910 a set of rules (e.g., PCC rules) indicating how data traffic of the multiaccess data connection is to be routed across the set of access networks. The method 900 includes determining 915 a plurality of reporting events and at least one QoS parameter (e.g., RTT, PLR, etc.) to be measured on each access network in the set of access networks. The method 900 includes sending 920, e.g., to the SMF, a policy response that includes the set of rules, the plurality of reporting events, and the at least one QoS parameter. The method 900 ends.

Disclosed herein is a first apparatus for measuring QoS parameters in a multiaccess data connection, according to embodiments of the disclosure. The first apparatus may be implemented by a user plane function, such as the UPF 141, the UPF 213, and/or the network apparatus 500, described above. The first apparatus includes a processor and a transceiver (i.e., supporting a network interface) that communicates with a SMF in a mobile communication network and communicates with a UE via a plurality of access networks. The processor receives a request from the SMF to establish a multiaccess connection for the UE, the multiaccess connection including a set of access networks, where the request includes a plurality of reporting events and QoS monitoring information indicating that at least one QoS monitoring procedure is to be used for taking measurements for at least one QoS parameter (e.g., RTT, PLR, etc.) on each access network in the set of access networks. The processor initiates at least one QoS monitoring procedure for taking measurements for the at least one QoS parameter on each access network in the set of access networks.

In some embodiments, the processor determines that a first reporting event in the plurality of reporting events is fulfilled, e.g., based on the measurements, and sends an event report to the SMF, the event report including information about the first reporting event. In such embodiments, the information about the first reporting event is based on the measurements for the at least one QoS parameter on each access network in the set of access networks.

In certain embodiments, determining that the first reporting event is fulfilled may include determining that an access network (i.e., a data path of the multiaccess connection) with a smallest RTT has changed, where the event report indicates which access network has the smallest RTT. In other embodiments, determining that the first reporting event is fulfilled may include determining that a RTT for a first access network exceeds a threshold value. In further embodiments, the event report may include a RTT value for each access network in the set of access networks.

In certain embodiments, the processor calculates a packet loss rate based on the measurements. In such embodiments, determining that the first reporting event is fulfilled includes determining that a packet loss rate for a first access network exceeds a threshold value. In some embodiments, the multiaccess connection includes a set of QoS flows, where the QoS monitoring information includes a first identifier indicating a first QoS flow in the set of QoS flows over which the measurements for the at least one QoS parameter are to be taken.

Disclosed herein is a first method for measuring QoS parameters in a multiaccess data connection, according to embodiments of the disclosure. The first method may be performed by a user plane function, such as the UPF 141, the UPF 213, and/or the network apparatus 500, described above. The first method includes receiving, e.g., from a SMF, a request to establish a multiaccess connection for a UE, where the multiaccess connection includes a set of access networks. Here, the request includes a plurality of reporting events and QoS monitoring information indicating that at least one QoS monitoring procedure is to be used to take measurements for at least one QoS parameter (e.g., RTT, PLR, etc.) on each access network in the set of access networks. The first method includes initiating at least one QoS monitoring procedure for taking measurements for the at least one QoS parameter on each access network in the set of access networks.

In some embodiments, the first method includes determining that a first reporting event in the plurality of reporting events is fulfilled, e.g., based on the measurements, and sending to the SMF an event report including information about the first reporting event. In such embodiments, the information about the first reporting event is based on the measurements for the at least one QoS parameter on each access network in the set of access networks.

In certain embodiments, determining that the first reporting event is fulfilled may include determining that an access network (i.e., a data path of the multiaccess connection) with a smallest RTT has changed, where the event report indicates which access network has the smallest RTT. In other embodiments, determining that the first reporting event is fulfilled may include determining that a RTT for a first access network exceeds a threshold value. In further embodiments, the event report may also include a RTT value for each access network in the set of access networks.

In certain embodiments, the first method further includes calculating a packet loss rate based on the measurements. In such embodiments, determining that the first reporting event is fulfilled includes determining that a packet loss rate for a first access network exceeds a threshold value. In some embodiments, the multiaccess connection includes a set of QoS flows, where the QoS monitoring information includes a first identifier indicating a first QoS flow in the set of QoS flows over which the measurements for the at least one QoS parameter are to be taken.

Disclosed herein is a second apparatus for measuring QoS parameters in a multiaccess data connection, according to embodiments of the disclosure. The second apparatus may be implemented by a communication device, such as the remote unit 105, the UE 201, and/or the user equipment apparatus 400, described above. The second apparatus includes a processor and a transceiver (i.e., supporting a radio interface) that communicates with a mobile communication network via a plurality of access networks. The processor sends a first message to establish a multiaccess data connection with the mobile communication network, where the multiaccess data connection includes a set of access networks (i.e., from the plurality of access networks). Via the transceiver, the processor receives a second message that accepts the establishment of the multiaccess data connection and receives a third message, where the second message includes a set of traffic routing rules (e.g., ATSSS rules) and the third message includes measurement information for the set of access networks of the multiaccess data connection. The processor applies the measurement information and the set of traffic routing rules to determine how to transmit data traffic across the set of access networks of the multiaccess data connection.

In some embodiments, the third message includes a PDU Session Modification Command. In some embodiments, the received measurement information is obtained by a UPF in the mobile communication network using at least one QoS monitoring procedure, where the measurement information includes measurements for the at least one QoS parameter for each access network in the set of access networks.

Disclosed herein is a second method for measuring QoS parameters in a multiaccess data connection, according to embodiments of the disclosure. The second method may be performed by a communication device, such as the remote unit 105, the UE 201, and/or the user equipment apparatus 400, described above. The second method includes sending a first message to establish a multiaccess data connection with the mobile communication network, where the multiaccess data connection includes a set of access networks. The second method includes receiving a second message that accepts the establishment of the multiaccess data connection and receiving a third message, where the second message includes a set of traffic routing rules (e.g., ATSSS rules) and the third message includes measurement information for the set of access networks of the multiaccess data connection. The second method includes applying the measurement information and the set of traffic routing rules to determine how to transmit data traffic across the plurality of access networks of the multiaccess data connection.

In some embodiments, the third message includes a PDU Session Modification Command. In some embodiments, the received measurement information is obtained by a UPF in the mobile communication network using at least one QoS monitoring procedure, where the measurement information includes measurements for the at least one QoS parameter for each access network in the set of access networks.

Disclosed herein is a third apparatus for measuring QoS parameters in a multiaccess data connection, according to embodiments of the disclosure. The third apparatus may be implemented by a session management function, such as the SMF 145, the SMF 209, and/or the network apparatus 500, described above. The third apparatus includes a processor and a transceiver (i.e., supporting a network interface) that communicates with a UPF in a mobile communication network and communicates with a UE. The processor receives, from the UE, a first message to establish a multiaccess data connection and sends, to the UPF, a request to establish a multiaccess connection for the UE, where the multiaccess data connection includes a set of access networks and where the request includes a plurality of reporting events and QoS monitoring information indicating that at least on QoS monitoring procedure is to be used for taking measurements for at least one QoS parameter (e.g., RTT, PLR, etc.) on each access network in the set of access network (i.e., on each data path of the multiaccess connection).

The processor sends, to the UE, a second message that accepts the establishment of the multiaccess data connection and receives, from the UPF, an event report including information about a first reporting event, where the second message including a set of traffic routing rules (e.g., ATSSS rules) and where the information about the first reporting event is based on measurements for the at least one QoS parameter on each access network in the set of access networks. The processor sends, to the UE, a third message that contains measurement information derived from the received event report.

In some embodiments, sending the third message includes sending a PDU Session Modification Command to the UE. In some embodiments, the second message indicates to the UE that measurements are to be provided by the network. In some embodiments, the first reporting event indicates that an access network with a smallest RTT has changed. In such embodiments, both the report and the third message indicate which access network has the smallest RTT. In certain embodiments, both the report and the third message further include a RTT value for each access network in the set of access networks.

In some embodiments, the processor further sends a policy request to a PCF in the mobile communication network and receives a policy response that includes the plurality of reporting events and the QoS monitoring information for the multiaccess data connection. In such embodiments, the policy response may further include an indication that at least one QoS monitoring procedure is to be used for taking measurements on each access network of the multiaccess data connection.

Disclosed herein is a third method for measuring QoS parameters in a multiaccess data connection, according to embodiments of the disclosure. The third method may be performed by a session management function, such as the SMF 145, the SMF 209, and/or the network apparatus 500, described above. The third method includes receiving, from a UE, a first message to establish a multiaccess data connection and sending, to a UPF, a request to establish a multiaccess connection for the UE, where the multiaccess data connection includes a set of access networks and where the request includes a plurality of reporting events and QoS monitoring information indicating that at least one QoS monitoring procedure is to be used to take measurements are to be taken for at least one QoS parameter (e.g., RTT, PLR, etc.) on each access network in the set of access networks (i.e., on each data path of the multiaccess connection).

The third method includes sending, to the UE, a second message that accepts the establishment of the multiaccess data connection and receiving, from the UPF, an event report including information about a first reporting event, where the second message including a set of traffic routing rules (e.g., ATSSS rules) and where the information is based on measurements for the at least one QoS parameter on each access network in the set of access networks. The third method includes sending, to the UE, a third message including measurement information derived from the received event report.

In some embodiments, sending the third message includes sending a PDU Session Modification Command to the UE. In some embodiments, the second message indicates to the UE that measurements are to be provided by the network. In some embodiments, where the first reporting event indicates that an access network with a smallest RTT has changed. In such embodiments, both the report and the third message indicate which access network has the smallest RTT. In certain embodiments, both the report and the third message further include a RTT value for each access network in the set of access networks.

In some embodiments, the third method further includes sending a policy request to a PCF in the mobile communication network and receiving a policy response that includes the plurality of reporting events and the QoS monitoring information for the multiaccess data connection. In such embodiments, the policy response may further include an indication that at least one QoS monitoring procedure is to be used for taking measurements on each access network of the multiaccess data connection.

Disclosed herein is a fourth apparatus for measuring QoS parameters in a multiaccess data connection, according to embodiments of the disclosure. The fourth apparatus may be implemented by a policy control function, such as the PCF 147, the PCF 211, and/or the network apparatus 500, described above. The fourth apparatus includes a processor and a transceiver (i.e., supporting a network interface) that communicates with a session management function (“SMF”) in a mobile communication network. The processor receives, e.g., from the SMF, a policy request for a requested multiaccess data connection that includes a set of access networks and generates a set of rules (e.g., PCC rules) indicating how data traffic of the multiaccess data connection is to be routed across the set of access networks. The processor determines a plurality of reporting events and at least one QoS parameter (e.g., RTT, PLR, etc.) to be measured on each access network in the set of access networks and sends, e.g., to the SMF, a policy response that includes the set of rules, the plurality of reporting events and the at least one QoS parameter.

In some embodiments, the policy response includes an indication that at least one QoS monitoring procedure is to be used to take measurements on each access network of the multiaccess data connection. In some embodiments, at least one PCC rule in the set of rules contains a QoS monitoring data element that indicates that at least one QoS monitoring procedure for taking measurements is to be activated for all access networks of the multiaccess data connection and indicates corresponding reporting events.

Disclosed herein is a fourth method for measuring QoS parameters in a multiaccess data connection, according to embodiments of the disclosure. The fourth method may be performed by a policy control function, such as the PCF 147, the PCF 211, and/or the network apparatus 500, described above. The fourth method includes receiving, e.g., from a SMF, a policy request for a requested multiaccess data connection that includes a set of access networks and generating a set of rules (e.g., PCC rules) indicating how data traffic of the multiaccess data connection is to be routed across the set of access networks. The fourth method includes determining a plurality of reporting events and at least one QoS parameter (e.g., RTT, PLR, etc.) to be measured on each access network in the set of access networks and sending, e.g., to the SMF, a policy response that includes the set of rules, the plurality of reporting events and the at least one QoS parameter.

In some embodiments, the policy response includes an indication that at least one QoS monitoring procedure is to be used to take measurements on each access network of the multiaccess data connection. In some embodiments, at least one PCC rule in the set of rules contains a QoS monitoring data element that indicates that at least one QoS monitoring procedure for taking measurements is to be activated for all access networks of the multiaccess data connection and indicates corresponding reporting events.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus in a mobile communication network, the apparatus comprising:
a transceiver that communicates with a Session Management Function (“SMF”) in the mobile communication network and communicates with a User Equipment (“UE”) via a plurality of access networks; and
a processor that:
receives, from the SMF, a request to establish a multiaccess connection for the UE, the multiaccess connection comprising a set of access networks, wherein the request comprises a plurality of reporting events and Quality of Service (“QoS”) monitoring information indicating that at least one QoS monitoring procedure is to be used for taking measurements for at least one QoS parameter on each access network in the set of access networks; and
initiates at least one QoS monitoring procedure for taking measurements for the at least one QoS parameter on each access network in the set of access networks.

2. The apparatus of claim 1, wherein the processor further:
determines, based on the measurements, that a first reporting event in the plurality of reporting events is fulfilled; and
sends to the SMF an event report comprising information about the first reporting event, wherein the information is based on the measurements for the at least one QoS parameter on each access network in the set of access networks.

3. The apparatus of claim 2, wherein determining that the first reporting event is fulfilled comprises determining that an access network with a smallest Round-Trip Time (“RTT”) has changed, wherein the event report indicates which access network has the smallest RTT.

4. The apparatus of claim 2, wherein determining that the first reporting event is fulfilled comprises determining that a Round-Trip Time (“RTT”) for a first access network exceeds a threshold value.

5. The apparatus of claim 2, wherein the processor calculates a packet loss rate based on the measurements, wherein determining that the first reporting event is fulfilled comprises determining that a packet loss rate for a first access network exceeds a threshold value.

6. The apparatus of claim 1, wherein the multiaccess connection comprises a set of Quality of Service (“QoS”) flows and wherein the QoS monitoring information comprises a first identifier indicating a first QoS flow in the set of QoS flows over which the measurements for the at least one QoS parameter are to be taken.

7. A User Equipment (“UE”) apparatus comprising:
a transceiver that communicates with a mobile communication network via a plurality of access networks; and
a processor that:
transmits a first message to establish a multiaccess data connection with the mobile communication network, the multiaccess data connection comprising a set of access networks in the plurality of access networks;
receives a second message that accepts the establishment of the multiaccess data connection, the second message comprising a set of traffic routing rules;
receives a third message, wherein the third message comprises measurement information for the set of access networks of the multiaccess data connection; and
applies the measurement information and the set of traffic routing rules to determine how to transmit data traffic across the set of access networks of the multiaccess data connection.

8. The apparatus of claim 7, wherein receiving the third message comprises receiving a PDU Session Modification Command.

9. The apparatus of claim 7, wherein the measurement information is obtained by a User Plane Function (“UPF”) in the mobile communication network using at least one Quality of Service (“QoS”) monitoring procedure, and wherein the measurement information comprises measurements for at least one QoS parameter for each access network in the set of access networks.

10. An apparatus in a mobile communication network, the apparatus comprising:
a transceiver that communicates with a User Plane Function (“UPF”) in the mobile communication network and communicates with a User Equipment (“UE”); and
a processor that:
receives, from the UE, a first message to establish a multiaccess data connection, the multiaccess data connection comprising a set of access networks;
transmits, to the UPF, a request to establish a multiaccess connection for the UE, wherein the request comprises a plurality of reporting events and Quality of Service (“QoS”) monitoring information indicating at least on QoS monitoring procedure for taking measurements for at least one QoS parameter on each access network in the set of access network; and
transmits, to the UE, a second message that accepts the establishment of the multiaccess data connection, the second message comprising a set of traffic routing rules;
receives, from the UPF, an event report comprising information about a first reporting event, wherein the information is based on measurements for the at least one QoS parameter on each access network in the set of access networks; and
transmits, to the UE, a third message comprising measurement information derived from the event report.

11. The apparatus of claim 10, wherein the first reporting event indicates that an access network with a smallest Round-Trip Time (“RTT”) has changed, wherein the report indicates which access network has the smallest RTT, and wherein the third message also indicates which access network has the smallest RTT.

12. The apparatus of claim 11, wherein the report further comprises a RTT value for each access network in the set of access networks, wherein the third message also comprises the RTT value for each access network in the set of access networks.

13. The apparatus of claim 10, wherein the processor further transmits a policy request to a policy control function in the mobile communication network and receives a policy response that comprises the plurality of reporting events and the QoS monitoring information for the multiaccess data connection, wherein the policy response further comprises an indication of at least one QoS monitoring procedure for taking measurements on each access network of the multiaccess data connection.

14. The apparatus of claim 10, wherein transmitting the third message comprises transmitting a PDU Session Modification Command to the UE.

15. The apparatus of claim 10, wherein the second message indicates to the UE that measurements are to be provided by the mobile communication network.
